(19) United States
(12) Patent Application Publication
(10) Pub. No.: US 2022/0309123 A1
(43) Pub. Date: Sep. 29, 2022

(54) FAST FOURIER TRANSFORM DEVICE AND DIGITAL FILTER DEVICE

(71) Applicant: NEC Corporation, Tokyo (JP)

(72) Inventor: Atsufumi SHIBAYAMA, Tokyo (JP)

(73) Assignee: NEC Corporation, Tokyo (JP)

(21) Appl. No.: 17/701,951

(22) Filed: Mar. 23, 2022

(30) Foreign Application Priority Data
Mar. 29, 2021 (JP) 2021-054596

(51) Int. Cl. G06F 17/14

(52) U.S. Cl. CPC G06F 17/142

(57) ABSTRACT

A fast Fourier transform device according to the present disclosure includes a data sorting unit that sorts N (N is an integer) number of first input data in a first order and outputs N number of first output data in a second order, a twiddle multiplication unit that performs twiddle multiplication that multiplies the N number of first output data by a twiddle factor, and outputs the N number of first output data in the second order, and a butterfly computation unit that performs butterfly computation on the N number of first output data and outputs N number of second output data in the second order, wherein the second order is an order where N number of second output data X(k) and X(N−k) have a time lag of one cycle or less, and a bit transition rate between consecutive cycles of the twiddle factor is small.

### INCORPORATION BY REFERENCE

This application is based upon and claims the benefit of priority from Japanese patent application No. 2021-054596, filed on Mar. 29, 2021, the disclosure of which is incorporated herein in its entirety by reference.

### TECHNICAL FIELD

The present disclosure relates to a Fast Fourier Transform device and a digital filter device that perform digital signal processing, for example.

### BACKGROUND ART

Fast Fourier transform (which is referred to hereinafter as “FFT”) is one important processing in digital signal processing. For example, frequency domain equalization (FDE) is known as technology to compensate for waveform distortion during signal transmission in wireless communication or wired communication. In frequency domain equalization, signal data in the time domain is first transformed into data in the frequency domain by fast Fourier transform, and then filtering for equalization is performed next. The data after filtering is then re-transformed into signal data in the time domain by inverse FFT (which is referred to hereinafter as “IFFT”), and thereby waveform distortion of the original signal in the time domain is compensated for. When FFT and IFFT are not distinguished, they are referred to collectively as “FFT/IFFT” hereinbelow.

“Butterfly computation” is generally used in FFT/IFFT. In this butterfly computation, data arranged in a sequential order are read in an order according to a specified rule and processed. Therefore, the sorting of data is needed in butterfly computation, and a RAM (Random Access Memory) circuit is mainly used for circuit implementation. In order to achieve higher processing in a subsequent stage of an FFT device and lower power consumption, the order of data output from the FFT device is important. Thus, technology to optimize the timing and the order of output of FFT results is disclosed in Japanese Patent No. 6358096.

The fast Fourier transform device disclosed in Japanese Patent No. 6358096 includes a first transform means for performing fast Fourier transform or inverse fast Fourier transform and generating a plurality of first output data, and outputting the plurality of first output data in a first order, and a first data sorting means for sorting the plurality of first output data output in the first order into a second order on the basis of output order setting.

Japanese Patent No. 6358096 discloses the FFT device capable of inputting data to be processed and outputting processing results in an arbitrary order, and it is capable of outputting outputs X(k) and X(N−k) with a time lag of at most one cycle. However, although Japanese Patent No. 6358096 discloses a method of implementing FFT by repeatedly using one butterfly computation circuit allocated to each of two stages of butterfly computation a plurality of times for an FFT data flow decomposed into two stages of butterfly computation by prime factor method, it does not disclose an optimum configuration when the degree of parallelism of processing is further increased to further increase the speed of FFT. To be specific, Japanese Patent No. 6358096 has a problem that the latency of digital signal processing using fast Fourier transform is large, and the circuit size and power consumption of a circuit that implements digital signal processing are not reducible.

### SUMMARY

One aspect of a fast Fourier transform device according to the present disclosure includes a data sorting unit configured to sort N (N is an integer) number of first input data in a first order, and output N number of first output data in a second order; a twiddle multiplication unit configured to perform twiddle multiplication that multiplies the N number of first output data by a twiddle factor, and output the N number of first output data in the second order; and a butterfly computation unit configured to perform butterfly computation on the N number of first output data, and output N number of second output data in the second order, wherein the second order is an order where N number of second output data X(k) (0≤k≤N−1) and X(N−k) have a time lag of one cycle or less for any index k between 1 and N−1 of X(k), and a bit transition rate between consecutive cycles of the twiddle factor is small.

One aspect of a digital filter device according to the present disclosure includes the above-described fast Fourier transform device, a complex conjugate generating means for generating, from first complex data being a complex number in time domain and composed of the N number of second output data output from the fast Fourier transform device, second complex data containing a conjugate complex number of each number; a filter factor generating means for generating, from first, second and third input filter factors of input complex numbers, first and second frequency domain filter factors of the complex numbers; a first filter means for performing filtering with the first frequency domain filter factor on the first complex data and outputting third complex data; a second filter means for performing filtering with the second frequency domain filter factor on the second complex data and outputting fourth complex data; and a complex conjugate combining means for combining the third complex data and the fourth complex data and generating fifth complex data.

The present disclosure provides a digital filter device in which the latency of digital signal processing using fast Fourier transform is small, and the size and power consumption of a circuit that implements digital signal processing are small.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration of an FFT device according to a first example embodiment;

FIG. 2 is a view showing the array of data sets in accordance with a sequential order according to the first example embodiment;

FIG. 3 is a view showing the array of data sets in accordance with a bit reversed order according to the first example embodiment;

FIG. 4 is a view showing the computation order of butterfly computation with a radix of 8 according to the first example embodiment;

FIG. 5 is a view showing the array of data sets in accordance with a power optimization data set sequential order according to the first example embodiment;

FIG. 6 is a view showing the array of twiddle factors in accordance with the power optimization data set sequential order according to the first example embodiment;

FIG. 7 is a view showing the computation order of butterfly computation with a radix of 8 according to the first example embodiment;

FIG. 8 is a block diagram showing a configuration example of a first data sorting circuit and a second data sorting circuit according to the first example embodiment;

FIG. 9 is a block diagram showing a configuration example of a third data sorting circuit according to the first example embodiment;

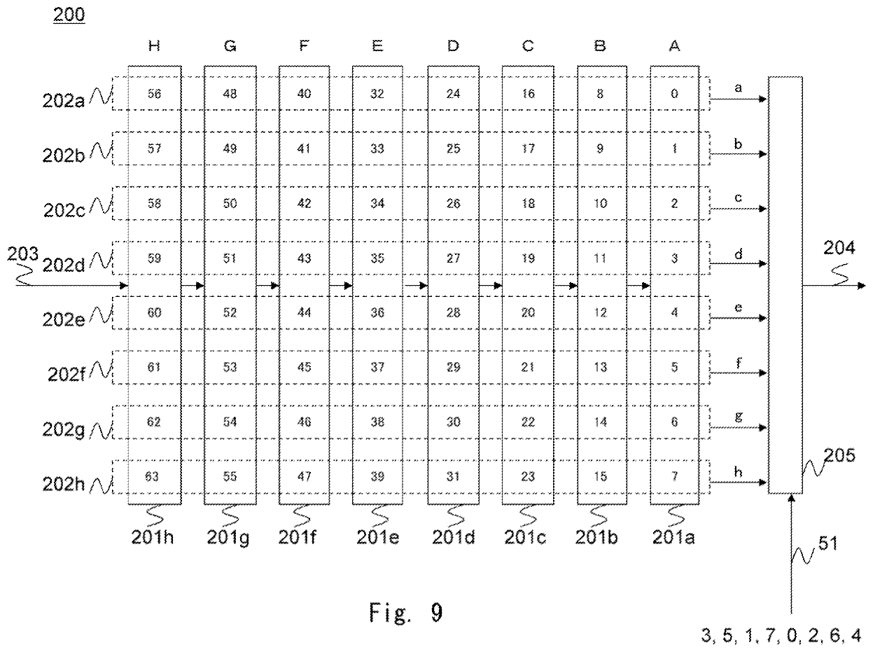

FIG. 10 is a block diagram showing a configuration example of a digital filter device according to the first example embodiment;

FIG. 11 is a block diagram showing a configuration of a complex conjugate generating circuit according to the first example embodiment;

FIG. 12 is a block diagram showing a configuration of a filter circuit according to the first example embodiment;

FIG. 13 is a block diagram showing a configuration of a filter circuit according to the first example embodiment;

FIG. 14 is a block diagram showing a configuration of a complex conjugate combining circuit according to the first example embodiment;

FIG. 15 is a block diagram showing a configuration of a filter factor generating circuit according to the first example embodiment;

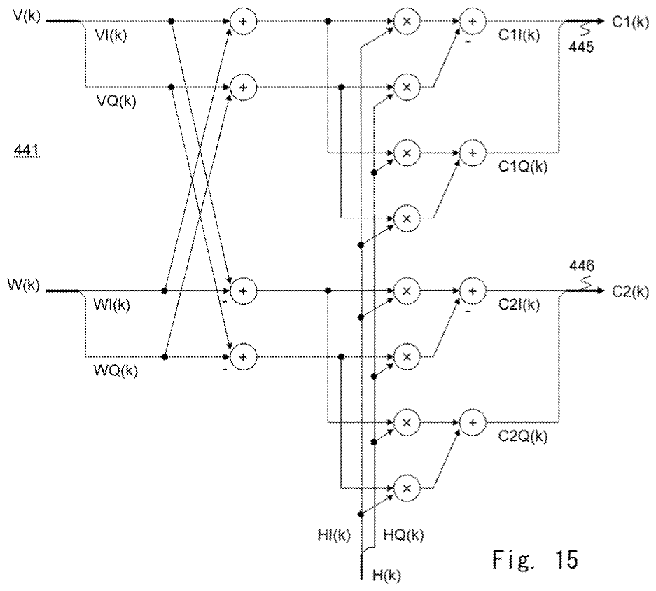

FIG. 16 is a view showing a data flow 500 of 64 point FFT using two stages of butterfly computation; and

FIG. 17 is a block diagram showing a configuration of an FFT device including a data sorting circuit.

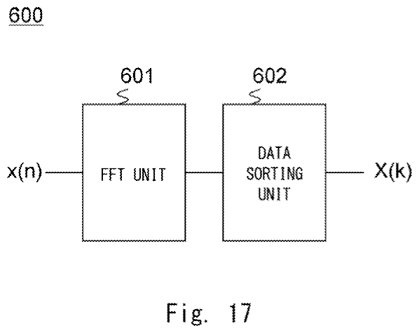

### EMBODIMENTS

### First Example Embodiment

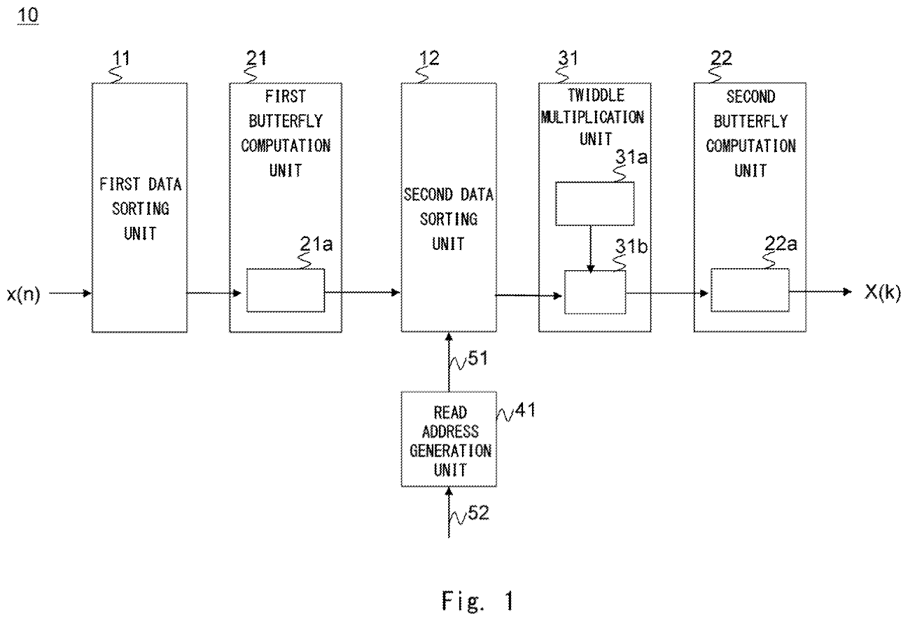

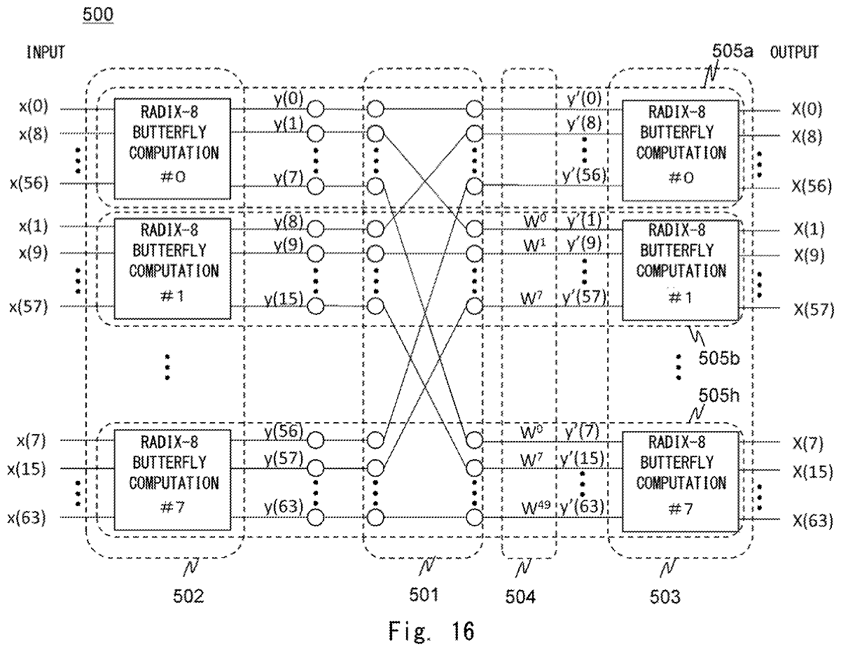

FIG. 1 is a block diagram showing a configuration example of an FFT device 10 according to a first example embodiment. The FFT device 10 processes 64 point FFT decomposed into two stages of butterfly computation with a radix of 8 in a pipeline fashion according to a data flow 500 shown in FIG. 16. The FFT device 10 receives input of data x(n) (n=0,1, . . . , N−1) in the time domain, performs Fourier transform of x(n) by FFT, and thereby generates and outputs a signal X(k) (k=0,1, . . . ,N−1) in the frequency domain. N is a positive integer representing the FFT block size.

The FFT device 10 includes a first data sorting unit 11, a first butterfly computation unit 21, a second data sorting unit 12, a twiddle multiplication unit 31, a second butterfly computation unit 22, and a read address generation unit 41. The FFT device 10 performs first data sorting, first butterfly computation, second data sorting, twiddle multiplication, and second butterfly computation in a pipeline fashion.

The first data sorting unit 11 and the second data sorting unit 12 are buffer circuits for data sorting. The first data sorting unit 11, which precedes the first butterfly computation unit 21, sorts a data sequence on the basis of the dependency relationship of data of the algorithm of FFT. Likewise, the second data sorting unit 12, which is subsequent to the first butterfly computation unit 21, receives input of a read address 51 and sorts a data sequence on the basis of the dependency relationship of data of the algorithm of FFT. In addition to the above sorting, the second data sorting unit 12 further performs sorting of output X(k) of the FFT device 10 so as to output the output X(k) and an output X(N−k) in the same cycle for an arbitrary value of k between 1 and N−1.

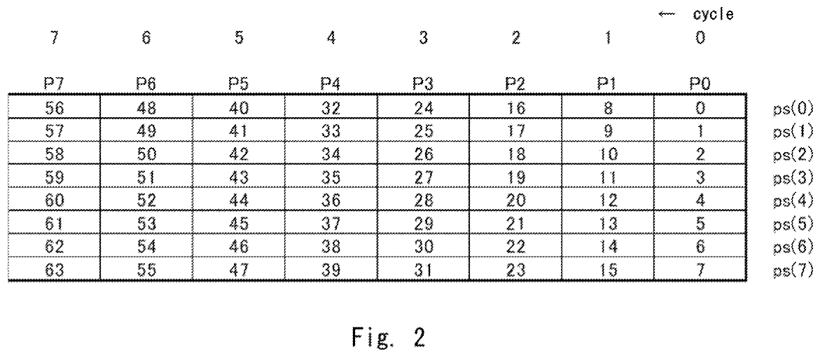

The FFT device 10 performs 64 point FFT with eight data parallel. In this case, the FFT device 10 receives input of data x(n) in the time domain, and generates and outputs a Fourier transformed signal X(k) in the frequency domain obtained by FFT. At this time, total 64 data, eight data each in 8 cycles, are input as input data x(n) in the order shown in FIG. 2. In this example, numbers from 0 to 63 shown in the table of FIG. 2 are indices of x(n).

To be specific, eight data x(0),x(1), . . . ,x(7) that constitute a data set P0 are input in the 0th cycle. Next, eight data x(8),x(9), . . . ,x(15) that constitute a data set P1 are input in the 1st cycle. Likewise, data that constitute data sets P2 to P7 are input in the 2nd cycle to the 7th cycle.

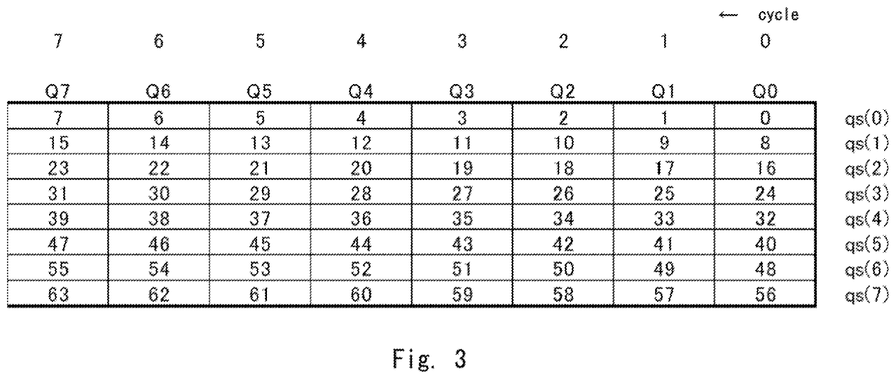

Then, the first data sorting unit 11 changes a “sequential order” shown in FIG. 2, which is the input order of the input data x(n), into a “bit reversed order” shown in FIG. 3, which is the order of input to the first butterfly computation unit 21.

The bit reversed order shown in FIG. 3 corresponds to an input data set to butterfly computation 502 with a radix of 8 in the first stage in the data flowchart shown in FIG. 16. To be specific, the first data sorting unit 11 outputs eight data x(0),x(8), . . . ,x(56) that constitute a data set Q0 in the 0th cycle. Then, it outputs eight data x(1),x(9), . . . ,x(57) that constitute a data set Q1 in the 1st cycle. Likewise, it outputs data that constitute data sets Q3 to Q7 in the 2nd cycle to the 7th cycle.

The “sequential order” and the “bit reversed order” are specifically described hereinbelow. The “sequential order” is the order related to eight data sets P0 to P7 shown in FIG. 2. A data set Ps (s=0,1, . . . ,7) is composed of eight data arranged sequentially from ps(0) to ps(7), and ps(i) is represented as follows.

ps(i)=8x+i Thus, the sequential order is a sequence where is number of data are sequentially arranged in data order from the first data into s number of data sets, each having i number of data.

The “bit reversed order” is the order related to eight data sets Q0 to Q7 shown in FIG. 3. A data set Qs (s=0,1, . . . ,7) is composed of eight data from qs(0) to qs(7), and qs(i) is represented as follows.

qs(i)=s+8i Thus, the bit reversed order is a sequence where is number of data are arranged every eight data from the first data into s number of data sets, each having i number of data.

As described above, i-th data of data constituting each data set Qs (s=0,1, . . . ,7) in the bit reversed order is s-th data constituting a data set Pi in the sequential order. This is expressed as follows.

Qs(i)=Pi(s) In this manner, Qs(i) and Pi(s) have a relationship where, regarding data constituting each data set, the order of the data set and the order for the data position in the data set are interchanged. Thus, the sorting of data input in the bit reversed order according to the bit reversed order results in the sequential order.

Each row ps(i) in FIG. 2 and each row qs(i) in FIG. 3 represent data input to i-th data in the subsequent stage. Eight numbers contained in each data set are identification information for identifying one of FFT points and, to be more precise, it is the value of the index n of x(n).

It should be noted that the sequential order and the bit reversed order are not limited to the examples shown in FIGS. 2 and 3. Specifically, each data set in the sequential order can be created by sequentially arranging data according to the number of FFT points, the number of cycles, and the number of data to be processed in parallel as described above. Then, each data set in the bit reversed order may be created by interchanging the order for the progression of the cycle and the order for the data position of data input in the sequential order as described above.

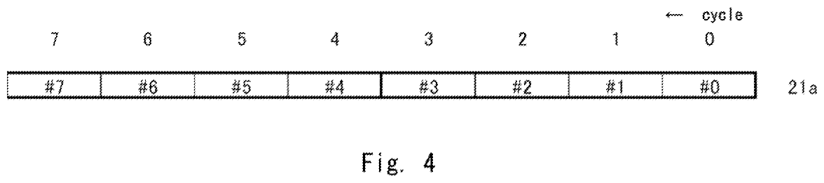

The first butterfly computation unit 21 is a butterfly circuit that processes first round butterfly computation 502 (first butterfly computation) of the butterfly computation with a radix of 8 that is performed in two stages in the data flow 500 of FIG. 16. The first butterfly computation unit 21 includes a radix-8 butterfly computation unit 21a and carries out radix-8 butterfly computation. To be specific, the first butterfly computation unit 21 performs eight times of radix-8 butterfly computation #0 to #7 that constitute the butterfly computation 502 in the order shown in FIG. 4.

Specifically, in the cycle 0, the radix-8 butterfly computation unit 21a receives input of the data set Q0 in the bit reversed order corresponding to the radix-8 butterfly computation #0 output from the first data sorting unit 11, and performs the radix-8 butterfly computation #0. In the cycle 1, the radix-8 butterfly computation unit 21a receives input of the data set Q1 in the bit reversed order corresponding to the radix-8 butterfly computation #1 output from the first data sorting unit 11, and performs the radix-8 butterfly computation #1. In the cycle 2, the radix-8 butterfly computation unit 21a receives input of the data set Q2 in the bit reversed order corresponding to the radix-8 butterfly computation #2 output from the first data sorting unit 11, and performs the radix-8 butterfly computation #2. In the cycle 3, the radix-8 butterfly computation unit 21a receives input of the data set Q3 in the bit reversed order corresponding to the radix-8 butterfly computation #3 output from the first data sorting unit 11, and performs the radix-8 butterfly computation #3. In the subsequent cycles also, in the cycles 4 to 7, the radix-8 butterfly computation unit 21a receives input of the data set Q4 to Q7 in the bit reversed order respectively corresponding to the radix-8 butterfly computation #4 to #7 output from the first data sorting unit 11, and performs the radix-8 butterfly computation #4 to #7.

The first butterfly computation unit 21 outputs results of the butterfly computation as data y(n) (0,1, . . . ,63) in the sequential order of FIG. 2.

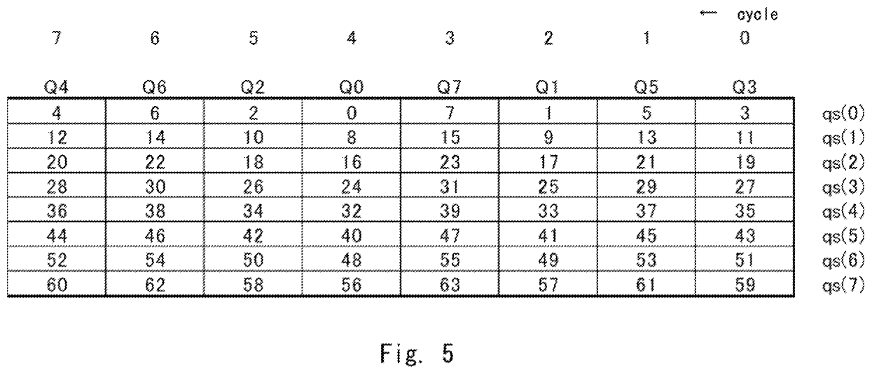

The second data sorting unit 12 sorts the data y(n) output in the sequential order from the first butterfly computation unit 21 into the order (which is referred to hereinafter as “power optimization data set bit reversed order”) shown in FIG. 5. The “power optimization data set bit reversed order” is related to the order when s number of data sets Qs created in the bit reversed order are output according to the progression of the cycle, and it can be specified by output order setting 52. In this example embodiment, the power optimization data set bit reversed order is specified as the order of Q3, Q5, Q1, Q7, Q0, Q2, Q6, Q4, and the data set Q3 is input in the cycle 0, the data set Q5 is input in the cycle 1, the data set Q1 is input in the cycle 2, the data set Q7 is input in the cycle 3, the data set Q0 is input in the cycle 4, the data set Q2 is input in the cycle 5, the data set Q6 is input in the cycle 6, and the data set Q4 is input in the cycle 7,

The second data sorting unit 12 receives input of the read address 51 output from the read address generation unit 41, and determines the output order. The read address generation unit 41 refers to the output order setting 52 provided from a higher-level circuit (not shown) such as a CPU (Central Processing Unit) and generates the read address 51 to be output to the second data sorting unit 12.

The twiddle multiplication unit 31 is a circuit that processes complex rotation on the complex plane in FFT after the first butterfly computation, and it corresponds to twiddle multiplication 504 in the data flow 500 of FIG. 16. The sorting of data is not carried out in the twiddle multiplication.

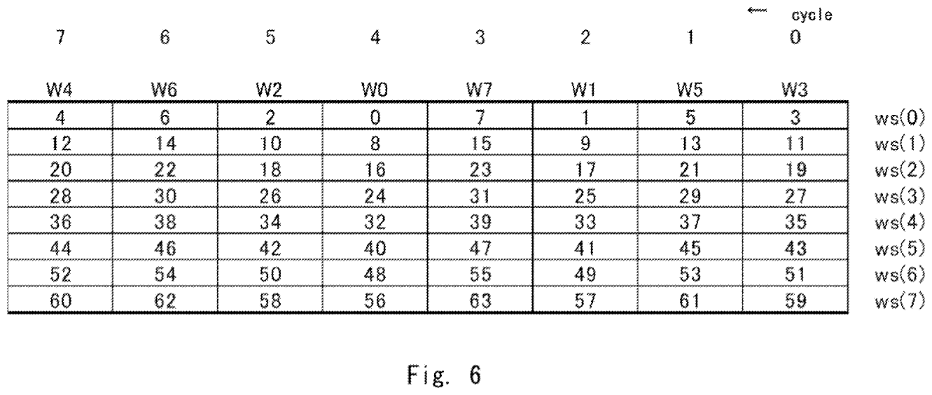

The twiddle multiplication unit 31 includes a twiddle factor table 31a and a twiddle multiplication unit 31b. The twiddle factor table 31a outputs a twiddle factor W(n) (n=0,1,,63) corresponding to data y(n) (n=0,1, . . . ,63) output in the “power optimization data set bit reversed order” from the second data sorting unit 12. W(n) is a twiddle factor corresponding to the data y(n). Thus, the order of outputting the twiddle factor W(n) by the twiddle multiplication unit 31 is uniquely determined as the “power optimization data set bit reversed order”, which is the order of outputting sorted data by the second data sorting unit 12. To be specific, when the second data sorting unit 12 outputs data in the “power optimization data set bit reversed order” shown in FIG. 5, the twiddle factor table 31a outputs the twiddle factor in the order shown in FIG. 6. As is obvious from FIGS. 5 and 6, the twiddle factor W(n) (n=0,1, . . . ,63) output from the twiddle multiplication unit 31 corresponds to y(n) output from the second data sorting unit 12.

The twiddle multiplication unit 31b performs twiddle multiplication by multiplying y(n) output from the second data sorting unit 12 by the twiddle factor W(n) output from the twiddle multiplication unit 31, and outputs this result to the second butterfly computation unit 22.

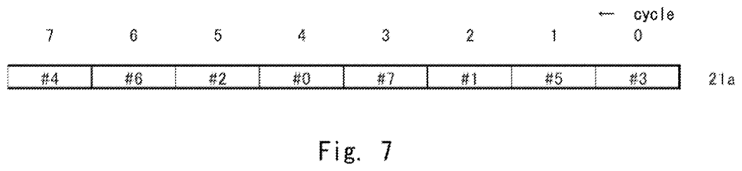

The second butterfly computation unit 22 is a butterfly circuit that processes second round butterfly computation 503 (second butterfly computation) of the butterfly computation with a radix of 8 that is performed in two stages in the data flow 500 of FIG. 16. The second butterfly computation unit 22 includes a radix-8 butterfly computation unit 22a and carries out radix-8 butterfly computation. To be specific, the second butterfly computation unit 22 performs eight times of radix-8 butterfly computation #0 to #7 that constitute the butterfly computation 503 in the order shown in FIG. 7.

Specifically, in the cycle 0, the radix-8 butterfly computation unit 22a receives input of the data set Q3 in the power optimization data set bit reversed order corresponding to the radix-8 butterfly computation #3 output from the second data sorting unit 12 and performs the radix-8 butterfly computation #3. In the cycle 1, the radix-8 butterfly computation unit 22a receives input of the data set Q5 in the power optimization data set bit reversed order corresponding to the radix-8 butterfly computation #5 output from the second data sorting unit 12 and performs the radix-8 butterfly computation #5. In the cycle 2, the radix-8 butterfly computation unit 22a receives input of the data set Q1 in the power optimization data set bit reversed order corresponding to the radix-8 butterfly computation #1 output from the second data sorting unit 12 and performs the radix-8 butterfly computation #1. In the cycle 3, the radix-8 butterfly computation unit 22a receives input of the data set Q7 in the power optimization data set bit reversed order corresponding to the radix-8 butterfly computation #7 output from the second data sorting unit 12 and performs the radix-8 butterfly computation #7. In the cycle 4, the radix-8 butterfly computation unit 22a receives input of the data set Q0 in the power optimization data set bit reversed order corresponding to the radix-8 butterfly computation #0 output from the second data sorting unit 12 and performs the radix-8 butterfly computation #0. In the cycle 5, the radix-8 butterfly computation unit 22a receives input of the data set Q2 in the power optimization data set bit reversed order corresponding to the radix-8 butterfly computation #2 output from the second data sorting unit 12 and performs the radix-8 butterfly computation #2. In the cycle 6, the radix-8 butterfly computation unit 22a receives input of the data set Q6 in the power optimization data set bit reversed order corresponding to the radix-8 butterfly computation #6 output from the second data sorting unit 12 and performs the radix-8 butterfly computation #6. In the cycle 7, the radix-8 butterfly computation unit 22a receives input of the data set Q4 in the power optimization data set bit reversed order corresponding to the radix-8 butterfly computation #4 output from the second data sorting unit 12 and performs the radix-8 butterfly computation #4.

The second butterfly computation unit 22 outputs results X(k) (k=0,1, . . . ,63) of the butterfly computation in the power optimization data set bit reversed order also.

The first data sorting unit 11 and the second data sorting unit 12 temporarily store input data and control selection and output of the stored data, and thereby achieve the sorting of data according to each of the bit reversed order in FIG. 3 and the power optimization data set bit reversed order in FIG. 5. A specific example of the data sorting unit is described hereinbelow.

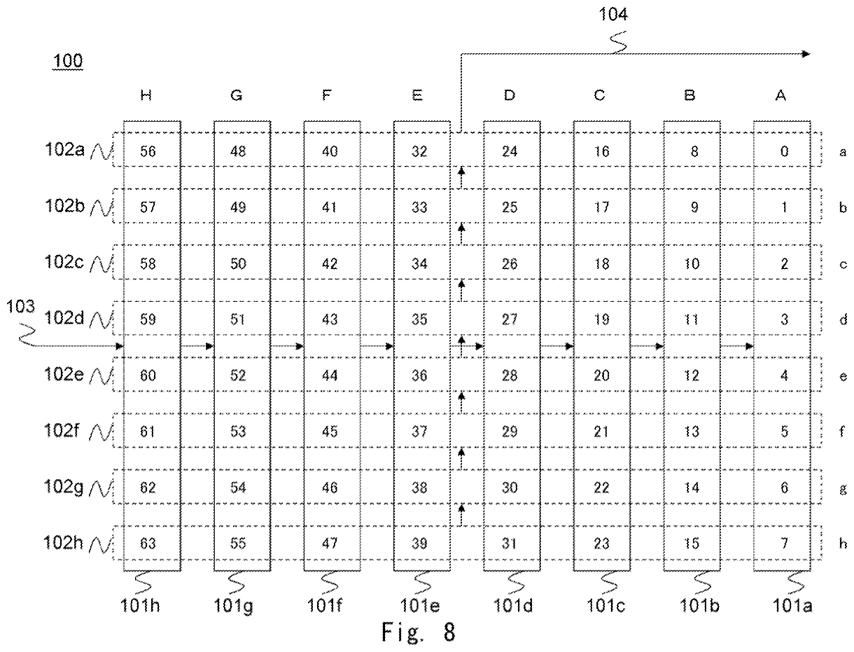

The first data sorting unit 11 is achievable by a data sorting unit 100 shown in FIG. 8, for example.

The data sorting unit 100 receives input of data sets D0 to D7 composed of eight data input as input information 103, two data sets each, in the first-input order in a FIFO buffer (First In First Out Buffer), and writes and stores them into data storage positions 101a to 101h. To be specific, the data sets D0 to D7 are stored in the data storage positions 101a to 101h, respectively.

Then, the data sorting unit 100 outputs the stored data, two data sets each, in the first-input order in the FIFO buffer. To be specific, the data sorting unit 100 reads eight data from data read positions 102a to 102h, respectively, and sorts them into one data set, and outputs eight data sets D0′ to D7′ as output information 104. In this way, the data sets D0′ to D7′ are created by sorting, in the order of data positions, the data contained in the data sets D0 to D7 arranged in the cycle order.

On the other hand. FIG. 8 is a block diagram of a data sorting unit 200 showing an implementation example of the second data sorting unit 12. The data sorting unit 200 receives input of data sets D0 to D7 composed of eight data input as input information 203, two data sets each, in the first-input order in a FIFO buffer, and writes and stores them into data storage positions 201a to 201h. Thus, the data sets D0 to D7 are sequentially stored in the data storage positions 201a to 201h, respectively. When viewing the stored data in the order of data positions, i.e., in the order of data storage positions 202a to 202h, the data sets D0′ to D7′ are stored in the data storage positions 202a to 202h, respectively.

After that, the data sorting unit 200 reads the stored data, one data set each, by a read circuit 205, and outputs them as output information 204. At this time, the read circuit 205 refers to the read address 51, selects any one of the data storage positions 202a to 202h, and reads any one of the eight data stored in the data storage positions 202a to 202h by one read operation. In this manner, data is able to be read in any combination and order by providing a read address in a desired combination and order that can be specified arbitrarily to the read address 51. For example, when read addresses are provided to the read address 51 in the order of addresses 3, 5, 1, 7, 0, 2, 6, 4, the data sorting unit 200 outputs the stored data in the order of data sets D3′, D5′, D1′, D7′, D0′, D2′, D6′, D4′. Specifically, the data are output in the power optimization data set bit reversed order shown in FIG. 5. The data sets D0′ to D7′ are created by sorting, in the order of data positions, the data contained in the data sets D0 to D7 arranged in the cycle order.

As described above, in the FFT device 10, two times of sorting according to each of the sequential order in FIG. 2, the bit reversed order in FIG. 3, and the power optimization data set bit reversed order in FIG. 5 are performed by the first data sorting unit 11 and the second data sorting unit 12.

By controlling each of the first data sorting unit 11 and the second data sorting unit 12 as described above, the processing order of the radix-8 butterfly computation processed by the first butterfly computation unit 21 and the second butterfly computation unit 22 is controllable into the orders shown in FIGS. 4 and 7, respectively. As a result, a plurality of data necessary for processing in the subsequent stage can be output at the same timing, which eliminates the need for further data sorting. This is described hereinafter by using the sorting of data in the second data sorting unit 12 and the processing order in the second butterfly computation unit 22 as an example.

A case of performing 64 point FFT with eight data parallel using the FFT device 10 shown in FIG. 1 is described hereinafter as an example. The FFT device 10 receives input of data x(n) (n=0,1, . . . ,63) in the time domain, and generates and outputs a Fourier transformed signal X(k) (k=0,1, . . . ,63) in the frequency domain obtained by FFT. The input data x(n) is input, eight data each during a period of 8 cycles, in the sequential order shown in FIG. 2, so that total 64 data x(n) are input. Note that only the index n of x(n) is shown in FIG. 2.

To be specific, eight data x(0),x(1), . . . ,x(7) that constitute the data set P0 are input in the 0th cycle. Next, eight data x(8),x(9), . . . ,x(15) that constitute the data set P1 are input in the 1st cycle. Likewise, data that constitute data sets P2 to P7 are input in the 2nd cycle to the 7th cycle.

On the other hand, as the output data X(k), total 64 data, eight data each during a period of 8 cycles, are output in the power optimization data set bit reversed order shown in FIG. 5, for example. In FIG. 5, only the index k of X(n) is shown. To be specific, the following data are output in each cycle.

In the cycle 0, eight data X(3),X(11), . . . ,X(59) that constitute the data set Q3 are output.

In the cycle 1, eight data X(5),X(13), . . . ,X(61) that constitute the data set Q5 are output.

In the cycle 2, eight data X(1),X(9), . . . ,X(57) that constitute the data set Q1 are output.

In the cycle 3, eight data X(7),X(15), . . . ,X(63) that constitute the data set Q7 are output.

In the cycle 4, eight data X(0),X(8), . . . ,X(56) that constitute the data set Q0 are output.

In the cycle 5, eight data X(2),X(10), . . . ,X(58) that constitute the data set Q2 are output.

In the cycle 6, eight data X(6),X(14), . . . ,X(62) that constitute the data set Q6 are output.

In the cycle 7, eight data X(4),X(12), . . . ,X(60) that constitute the data set Q4 are output.

In this manner, two output data X1(k1) and X2(k2) where the sum of the indices k1 and k2 is 64, which corresponds to the number of FFT points, are always output in consecutive cycles. Specifically, the FFT device 10 is able to output, for any index k between 1 and N-1, outputs X(k) and X(N−k) (N=64) with a time lag of at most one cycle.

As described above, in this example embodiment, the data sets are output in the order of Q3, Q5, Q1, Q7, Q0, Q2, Q6, Q4 in the cycles 0 to 7, which allows the outputs X(k) and X(N−k) (N=64) to be output with a time lag of at most one cycle. Besides the order described in this example embodiment, there are a plurality of orders of data sets that allow the outputs X(k) and X(N−k) (N=64) to be output with a time lag of at most one cycle, and the outputs X(k) and X(N−k) (N=64) are output with a time lag of at most one cycle also when the data sets are output in the order of Q0, Q7, Q1, Q6, Q2, Q5, Q3, Q4 or in the order of Q0, Q7, Q2, Q5, Q3, Q4, Q1, Q6. In the following description, those orders that allow the outputs X(k) and X(N−k) (N=64) to be output with a time lag of at most one cycle are referred to as “optimization data set bit reversed orders”.

Differences between the “power optimization data set bit reversed order”, which is the order of Q3, Q5, Q1, Q7, Q0, Q2, Q6, Q4, employed in this example embodiment and the “optimization data set bit reversed order”, which is the order of Q0, Q7, Q1, Q6, Q2, Q5, Q3, Q4 and the like are as follows.

In this example embodiment, the output order of the FFT device 10 is determined as the power optimization data set bit reversed order, which is the output order of the second data sorting unit 12. Likewise, the order of outputting the twiddle factor W(n) from the twiddle multiplication unit 31 according to this example embodiment is determined by the power optimization data set bit reversed order, which is the output order of the second data sorting unit 12 and, to be specific, it is output in the order shown in FIG. 6.

The value of the twiddle factor W(n) is a value specific to FFT, and it is not dependent on the value of data input to the FFT device 10. In FIG. 6, the data sets W0 to W7 are composed of eight data from ws(0) to ws(7), and the values of ws(0) to ws(7) vary according to the order of W3, W5, W1, W7, W0, W2, W6, W4, which is the power optimization data set bit reversed order, from the cycles 0 to 7. With regard to the power consumption of the twiddle multiplication unit 31, variations of the values of the eight data from ws(0) to ws(7) significantly affect the power consumption. To be specific, in binary values that represent the twiddle factor W(n) using binary numbers, the bit-by-bit operating rate (toggle rate) of the eight data from ws(0) to ws(7) significantly affects the power consumption. This is because the dynamic power consumption (dynamic power) P of a digital signal processing circuit implemented by a CMOS (Complementary Metal Oxide Semiconductor) circuit can be represented by the following Equation (1):

P=(1/2)*a*C*V2*f (1)

where a: circuit operating rate

C: load capacity

V: voltage

f: operating frequency, and the bit-by-bit operating rate of the eight data from ws(0) to ws(7) significantly affects the circuit operating rate a. Thus, selecting the output order that reduces the bit-by-bit operating rate of the eight data from ws(0) to ws(7) is effective for reducing the power consumption of the twiddle multiplication unit 31.

One specific method of selecting the output order that reduces the bit-by-bit operating rate of the eight data from ws(0) to ws(7) is a method using the Hamming distance. The Hamming distance is the distance between two data strings, and in the case of binary data, it equals the number of bit positions in which the two binary bits are different. Thus, the operating rate when certain twiddle factor data changes is equal to the Hamming distance between the factor data value before change and the factor data value after change. Therefore, the operating rate related to the twiddle factor W(n) can be calculated by the sum of Hamming distances related to the twiddle factor W(n) during FFT.

For example, the operating rate related to the twiddle factor W(n) by the power optimization data set bit reversed order shown in FIG. 6 can be calculated as:

H(0)=Hamming(3,5)+Hamming(5,5)+Hamming(1,7)+Hamming(7,0)+Hamming(0,2) +Hamming(2,6)+Hamming(6,4) where the Hamming distance between the twiddle factors W(n) and W(j) is Hamming(i,j), and the Hamming distance related to the data ws(i) as H(i), since the data ws(0) is W(3) in the cycle 0, W(5) in the cycle 1, W(1) in the cycle 2, W(7) in the cycle 3, W(0) in the cycle 4, W(2) in the cycle 5, W(6) in the cycle 6, and W(4) in the cycle 7.

Likewise, H(1) to H(7) can be calculated as: H(1)=Hamming(11,13)+Hamming(13,9)+Hamming(9,15)+Hamming(15,8)+Hammi ng(8,10)+Hamming(10,14)+Hamming(14,12), H(2)=Hamming(19,21)+Hamming(21,17)+Hamming(17,23)+Hamming(23,16)+Ha mming(16,18)+Hamming(18,22)+Hamming(22,20), H(3)=Hamming(27,29)+Hamming(29,25)+Hamming(25,31)+Hamming(31,24)+Ha mming(24,26)+Hamming(26,30)+Hamming(30,28), H(4)=Hamming(35,37)+Hamming(37,33)+Hamming(33,39)+Hamming(39,32)+Ha mming(32,34)+Hamming(34,38)+Hamming(38,36), H(5)=Hamming(43,45)+Hamming(45,41)+Hamming(41,47)+Hamming(47,40)+Ha mming(40,42)+Hamming(42,46)+Hamming(46,44), H(6)=Hamming(51,53)+Hamming(53,49)+Hamming(49,55)+Hamming(55,48)+Ha mming(48,50)+Hamming(50,54)+Hamming(54,52), and H(7)=Hamming(59,61)+Hamming(61,57)+Hamming(57,63)+Hamming(63,56)+Ha mming(56,58)+Hamming(58,62)+Hamming(62,60).

Thus, the operating rate A related to the twiddle factor W(n) can be calculated as:

A=P=H(0)+H(1)+H(2)+H(3)+H(4)+H(5)+H(6)+H(7) using the sum P of Hamming distances related to the twiddle factor W(n).

The “power optimization data set bit reversed order” in this example embodiment is the order selected as the order with the lowest operating rate A related to the twiddle factor W(n) from a plurality of candidates for the “optimization data set bit reversed order” that allows the outputs X(k) and X(N−k) (N=64) to be output with a time lag of at most one cycle. Thus, the “power optimization data set bit reversed order” in this example embodiment is the order with the lowest power consumption related to the twiddle factor table 31a that outputs the twiddle factor W(n) among the plurality of candidates for the “optimization data set bit reversed order”.

Although the twiddle multiplication unit 31b that constitutes the twiddle multiplication unit 31 is affected by the operating rate of y(n) output from the second data sorting unit 12 in addition to the operating rate of the twiddle factor W(n), since arbitrary data is input to the FFT device 10, the operating rate of y(n) is considered to be constant in the long run regardless of the order of outputting y(n). Likewise, the operating rates of the data sorting unit and the butterfly computation unit that constitute the FFT device 10 are also considered to be constant in the long run regardless of the order of processing since arbitrary data is input to the FFT device 10. Thus, the “power optimization data set bit reversed order” in this example embodiment is the order with the lowest power consumption of the FFT device 10 among the plurality of candidates for the “optimization data set bit reversed order”.

### Effects of First Example Embodiment

As described above, in this example embodiment, the FFT device 10 is able to output data in an arbitrary order by specifying the order using the output order setting 52.

For example, when, for output data X(k) (k=0,1, . . . ,N−1), computation is carried out between X(k) and X(N−k) for any index k between 1 and N−1 in the subsequent stage of the FFT device 10, X(k) and X(N−k) can be output with a time lag of at most one cycle. Thus, there is no need to add another circuit for sorting output.

Further, a circuit to be added in order to allow specifying the order of outputting output data is only the read address generation unit 41, and its circuit size is very small.

This suppresses an increase in processing latency, circuit size and power consumption as a whole including processing in the subsequent stage.

Further, in this example embodiment, processing is performed in the order that minimizes power related to twiddle multiplication. This reduces power consumption of the FFT process as a whole.

Although FFT is described as an example in this example embodiment, the same applies to IFFT. Specifically, an increase in the speed of processing in the subsequent stage of IFFT is achieved by applying the control method of this example embodiment to an IFFT processing device and optimizing the output order of processing results in consideration of the details of processing in the subsequent stage of IFFT.

### Second Example Embodiment

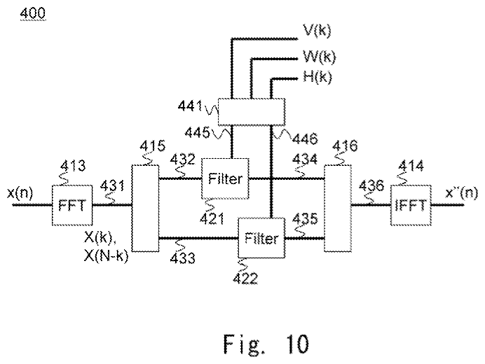

FIG. 10 is a block diagram showing a configuration of a digital filter device 400 according to a second example embodiment of the present disclosure. The digital filter device 400 includes an FFT circuit 413, an IFFT circuit 414, a complex conjugate generating circuit 415, a complex conjugate combining circuit 416, a filter circuit 421, a filter circuit 422, and a filter factor generating circuit 441.

The digital filter device 400 receives input of a complex signal in the time domain:

x(n)=r(n)+js(n) (1).

The FFT circuit 413 transforms, by FFT, the input complex signal x(n) into a complex signal 431 in the frequency domain:

X(k)=A(k)+jB(k) (2).

Note that n is an integer of 0<n<N−1 indicating a signal sample number in the time domain, N is an integer of 0<N indicating the number of transform samples of FFT, and k is an integer of 0≤k≤N−1 indicating a frequency number in the frequency domain.

The FFT circuit 413 generates:

X(N−k)=A(N−k)+jB(N−k) (3)

from X(k) and outputs it.

The complex conjugate generating circuit 415 receives input of X(N−k) output from the FFT circuit 413 for each of the frequency number k of 0≤k≤N−1, and generates a complex conjugate of X(N−k):

X*(N−k)=A(N−k)−jB(N−k) (4).

The complex conjugate generating circuit 415 outputs an input complex signal X(k) as a complex signal 432, and outputs a generated complex signal X*(N−k) as a complex signal 433.

Then, the filter factor generating circuit 441 generates complex factors:

C1(k)={V(k)+W(k)}×H(k) (5)

C2(k)={V(k)−V(k)}×H(k) (6)

from input complex factors V(k), W(k) and H(k) for each of the frequency number k of 0≤k≤N−1.

The complex factors V(k), W(k) and H(k) correspond to real filter factors when performing filtering by real number calculation in the time domain, which are factors in the frequency domain provided from a higher-level circuit (not shown) of the digital filter device 400. The details of V(k), W(k) and H(k) are described later.

The filter factor generating circuit 441 outputs the generated complex factor C1(k) as a complex signal 445. Further, the filter factor generating circuit 441 generates a complex signal C2(N−k) from the complex signal C2(k) (Expression (6)), and outputs it as a complex signal 446.

Next, the filter circuit 421 performs complex filtering by complex number multiplication using C1 (Expression (5)) output to the complex signal 445 from the filter factor generating circuit 441 for X(k) (Expression (2)) output to the complex signal 432 from the complex conjugate generating circuit 415. To be specific, the filter circuit 421 calculates a complex signal:

X′(k)=X(k)×C1(k) (7)

for each of the frequency number k of 0≤k≤N−1, and outputs it as a complex signal 434.

Likewise, the filter circuit 422 performs complex filtering by complex number multiplication using C2 (N−k) (Expression (6)) output to the complex signal 446 from the filter factor generating circuit 441 for X*(N−k) (Expression (6)) output to the complex signal 433 from the complex conjugate generating circuit 415. To be specific, the filter circuit 422 calculates a complex signal:

X′*(N−k)=X*(N−k)×C2(N−k) (8)

for each of the frequency number k of 0≤k≤N−1, and outputs it as a complex signal 435.

C1(k) and C2(k) can be expressed as:

C1(k)=C1I(k)+jC1Q(k) (9)

C2(k)=C2I(k)+JC2Q(k) (10),

separated into a real part and an imaginary part.

Then, the complex conjugate combining circuit 416 generates a complex signal X″(k) that combines X′(k) (Expression (7)) output to the complex signal 434 from the filter circuit 421 and X′*(N−k) (Expression (8)) output to the complex signal 435 from the filter circuit 422. To be specific, the complex conjugate combining circuit 416 calculates

X″(k)=1/2×{X′(k)+X″*(N−k)} (11)

for each of the frequency number k of 0≤k≤N−1, and outputs it as a complex signal 436.

After that, the IFFT circuit 414 generates, by IFFT, a complex signal x″(n) in the time domain for X″(k) (Expression (11)) output to the complex signal 436 from the complex conjugate combining circuit 416 for each of the frequency number k of 0≤k≤N−1, and outputs it.

The FFT device 10 according to the first embodiment of the present disclosure can be used as a method of implementing the FFT circuit 413. Alternatively, an FFT device 20 according to the second embodiment of the present disclosure can be used as a method of implementing the FFT circuit 413.

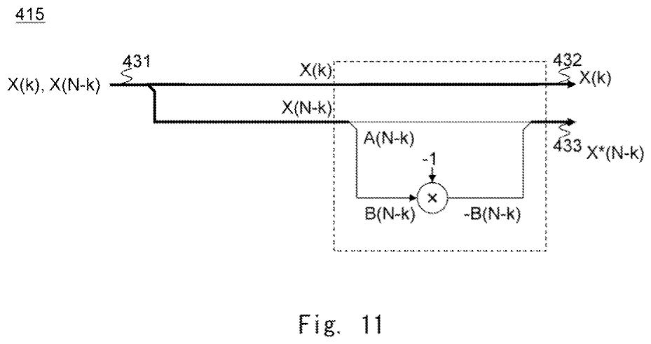

FIG. 11 is a block diagram showing the details of the configuration of the complex conjugate generating circuit 415. The complex conjugate generating circuit 415 receives input of X(k)(=A(k)+jB(k): Expression (2)) contained in the output of the FFT circuit 413 and outputs this value. Further, the complex conjugate generating circuit 415 receives input of X(N−k) (=A(N−k)+jB(N-k): Expression (3)) contained in the output of the FFT circuit 413, and calculates and outputs

X*(N−k)=A(N−k)−jB(N−k) (4).

X(k) and X*(N−k) are expressed as

X(k)=XI(k)+jXQ(k) (12)

X*(N−k)=X*I(N−k)+jX*Q(N−k) (13),

separated into a real part and an imaginary part.

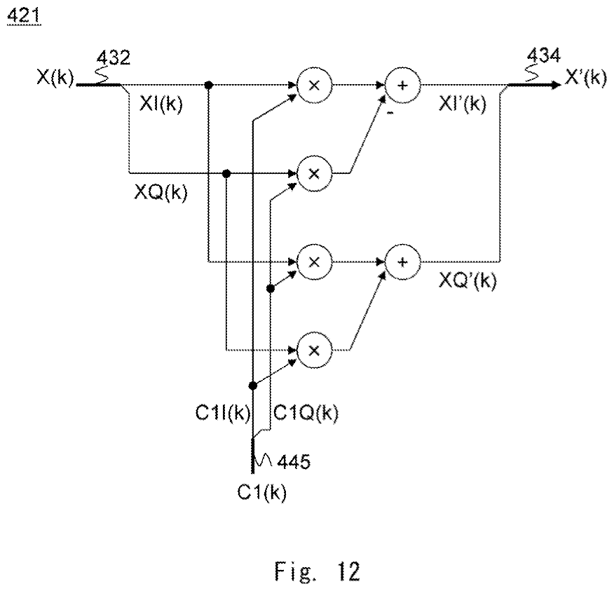

FIG. 12 is a block diagram showing the details of the configuration of the filter circuit 421. The filter circuit 421 receives input of X(k) (=XI(k)+jXQ(k): Expression (12)) output to the complex signal line 432 from the complex conjugate generating circuit 415 and the complex factor C1(k)(=C1I(k)+jC1Q(k): Expression (9)), and calculates and outputs

X′(k)=XI′(k)+jXQ′(k)=X(k)×C1(k) (14).

XI′(k) and XQ′(k) are a real part and an imaginary part of X′(k), respectively, and expressed as the following Equations.

XI′(k)=XI(k)×C1I(k)−XQ(k)×C1Q(k) (15)

XQ′(k)=XI(k)×C1Q(k)+XQ(k)×C1I(k) (16)

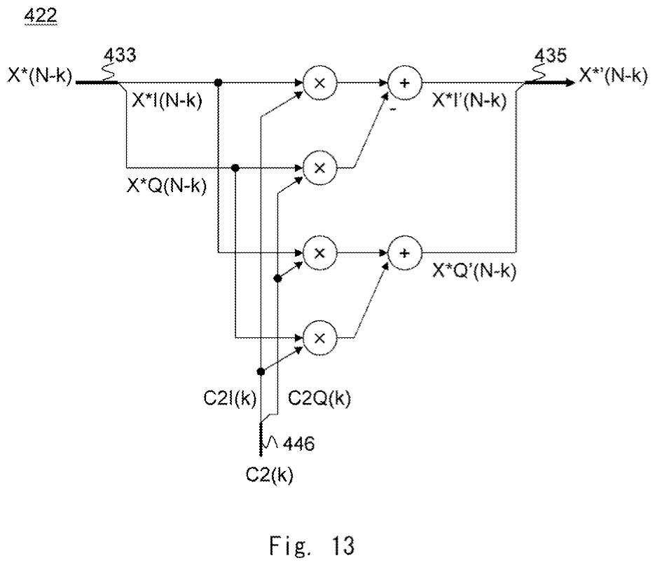

FIG. 13 is a block diagram showing the details of the configuration of the filter circuit 422. The filter circuit 422 receives input of X*(N−k)(=X*I(N−k) +jX*Q(N-k): Expression (13)) output to the complex signal line 433 from the complex conjugate generating circuit 415 and the complex factor C2(k)=C2I(k)+JC2Q(k): Expression (10)), and calculates and outputs

X′*(N−k)=X′*(N−k)+jX*Q′(N-k)=X*(N−k)×C2(N−k) (17).

X*I′(N−k) and X*Q′(N−k) are a real part and an imaginary part of X′*(N−k), respectively, and expressed as the following Equations.

X*I′(N−k)=X*I(N−k)×C2I(N−k)-X*Q(N−k)×C2Q(N−k) (18)

X*Q′(N−k)=X*I(N−k)×C2Q(N−k)-X*Q(N−k)×C2I(N−k) (19)

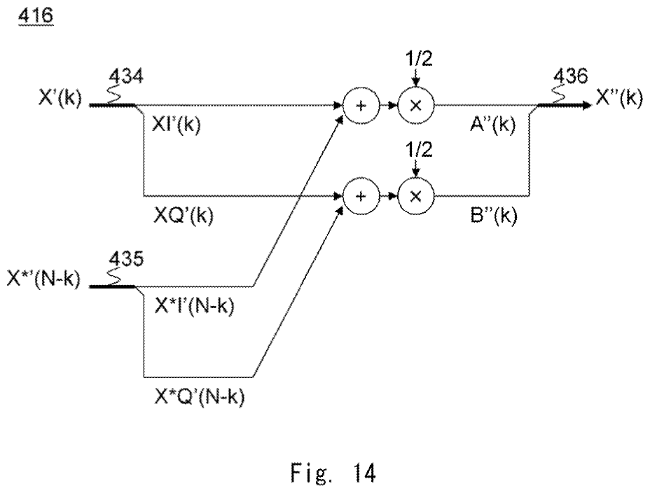

FIG. 14 is a block diagram showing the details of the configuration of the complex conjugate combining circuit 416. The complex conjugate combining circuit 416 receives input of X′(k)(=XI′(k)+jXQ′(k): Expression (14)) output to the complex signal line 434 from the filter circuit 421 and X′*(N−k)(=X*I′(N−k) +jX*Q′(N−k): Expression (17)) output to the complex signal 435 from the filter circuit 422 for each of the frequency number k of 0≤k≤N−1, and calculates and outputs

X″(k)=XI″(k)+jXQ″(k)=1/2{X′(k)+X′*(N−k)} (20).

XI″(k) and XQ″(k) are a real part and an imaginary part of X″(k), respectively, and expressed as the following Equations.

XI″(k)=1/2{XI′(k)+X*I′(N−k)} (21)

XQ″(k)=1/2{XQ′(k)+X*Q′(N−k)} (22)

where XI′(k), XQ′(k), X*I′(N−k), X*Q′(N−k) are those represented by Equations (15), (16), (18), and (19), respectively.

The filter factor generating circuit 441 generates the complex factors C1(k) and C2(k) to be used in the filter circuits 421 and 422. FIG. 18 is a block diagram showing the details of the configuration of the filter factor generating circuit 441. The filter factor generating circuit 441 calculates V(k)+W(k) and V(k)−W(k) from the complex factors V(k) and W(k) that are input from a higher-level circuit (not shown) for each of the frequency number k of 0≤k≤N−1.

V(k)+W(k)=VI(k)+WI(k)+jVQ(k)+jWQ(k) (23)

V(k)−W(k)=VI(k)−WI(k)+jVQ(k)−jWQ(k) (24)

VI(k) and VQ(k) are a real part and an imaginary part of V(k), respectively, and WI(k) and WQ(k) are a real part and an imaginary part of W(k), respectively.

Further, H(k) can be expressed as

H(k)=HI(k)+jHQ(k) (25),

separated into a real part and an imaginary part.

Then, the filter factor generating circuit 441 calculates and outputs the complex factors C1(k) and C2(k) defined by the following Equations.

C1(k)=C1I(k)+jC1Q(k)={V(k)+W(k)}×H(k) (26)

C2(k)=C2I(k)+jCQ(k)={V(k)−W(k)}×H(k) (27)

C1I(k) and C1Q(k) are a real part and an imaginary part of C1(k), respectively, and C2I(k) and C2Q(k) are a real part and an imaginary part of C2(k), respectively.

Substituting Equations (23) and (25) in Equation (26) yields:

C1(k)={VI(k)+WI(k)+jVQ(k)+jWQ(k)}×{HI(k)+jHQ(k)} (28).

Accordingly, the following Equations are established.

C1I(k)={VI(k)+WI(k)}×HI(k)−{VQ(k)+WQ(k)}×HQ(k) (29)

C1Q(k)={VQ(k)+WQ(k)}×HI(k)+{VI(k)+WI(k)}×HQ(k) (30)

Likewise, substituting Equations (24) and (25) in Equation (27) yields:

$$\begin{matrix}C 2 ( k ) = C 2 I ( k ) + jC 2 Q ( k ) \\ = \{ V ( k ) - W ( k ) \} \times H ( k ) \\ = \{ VI ( k ) - WI ( k ) + jVQ ( k ) - jWQ ( k ) \times \{ HI ( k ) + jHQ ( k ) \} .\end{matrix} \qquad ( 31 )$$

Accordingly, the following Equations are established.

C2I(k)={VI(k)−WI(k)}×HI(k)−{VQ(k)−WQ(k)}×HQ(k) (32)

C2Q(k)={VQ(k)−WQ(k)}×HI(k)+{VI(k)−WI(k)}×HQ(k) (33)

As described above, the digital filter device 400 transforms, by FFT, an input signal in the time domain into a complex signal in the frequency domain. Then, the digital filter device 400 performs filtering of each of the real part and the imaginary part of the complex signal in the frequency domain independently of each other by using two types of factors generated from V(k), W(k) and H(k), and transforms, by IFFT, results into a signal in the time domain. In this manner, in the digital filter device 400, each of FFT and IFFT is performed only once on an input signal in the time domain.

The two types of factors used in filtering allow minimizing the number of times of FFT and IFFT. Hereinafter, the physical meaning of V(k), W(k) and H(k) and the principle that enables filtering in the frequency domain that is the equivalent of desired filtering in the time domain to be performed by filtering using the factors C1(k) and C2(k) generated from them are described.

In this example embodiment, a complex conjugate generating circuit 15 generates X*(N−k) from a complex signal in the frequency domain:

X(k)=R(k)+jS(k) (34)

that is generated by complex FFT of the input complex signal in the time domain x(n)(=r(n)+js(n): Equation (1)).

R(k) is a complex signal in the frequency domain obtained by real number FFT of a real part signal r(n) of a real number in the time domain, and S(k) is a complex signal in the frequency domain obtained by real number FFT of an imaginary part signal s(n) of a real number in the time domain. By the symmetry of the complex conjugate, the following Equations are established:

X*(N−k)=R(k)−jS(k) (35)

where X*(N−k) is the complex conjugate of X(N−k).

From Equations (14), (34) and (26), the following Equation is established.

$$\begin{matrix}{X}^{′} ( k ) = X ( k ) \times C 1 ( k ) \\ = \{ R ( k ) + jS ( k ) \} \times \{ V ( k ) + W ( k ) \} \times H ( k ) \\ = R ( k ) V ( k ) H ( k ) + R ( k ) W ( k ) H ( k ) + \\ jS ( k ) V ( k ) H ( k ) + jS ( k ) W ( k ) H ( k )\end{matrix} \qquad ( 36 )$$

Further, from Equations (17), (35) and (27), the following Equation is established.

$$\begin{matrix}{X}^{* ′} ( N - k ) = {X}^{*} ( N - k ) \times C 2 ( N - k ) \\ = \{ R ( k ) - jS ( k ) \} \times \{ V ( k ) - W ( k ) \} \times H ( k ) \\ = R ( k ) V ( k ) H ( k ) - R ( k ) W ( k ) H ( k ) - \\ jS ( k ) V ( k ) H ( k ) + jS ( k ) W ( k ) H ( k ) .\end{matrix} \qquad ( 37 )$$

Substituting Equations (36) and (37) in Equation (20) yields:

$$\begin{matrix}{X}^{″} ( k ) = 1 / 2 \times \{ {X}^{′} ( k ) + {X}^{* ′} ( N - k ) \} \\ = 1 / 2 \times \{ 2 \times R ( k ) V ( k ) H ( k ) + 2 \times jS ( k ) W ( k ) H ( k ) \} \\ = R ( k ) V ( k ) H ( k ) + jS ( k ) W ( k ) H ( k ) \\ = \{ R ( k ) V ( k ) + jS ( k ) W ( k ) \} \times H ( k ) .\end{matrix} \qquad ( 38 )$$

Equation (38) expresses the signal X″(k) before IFFT by using the filter factors V(k), W(k) and H(k), and R(k) and S(k) in the signal X(k) after FFT. R(k) is a complex signal in the frequency domain obtained by real number FFT of a real part signal r(n) of a real number in the time domain. S(k) is a complex signal in the frequency domain obtained by real number FFT of an imaginary part signal s(n) of a real number in the time domain. Thus, Equation (38) represents the details of filtering that is performed on the signal X(k) after FFT. From Equation (38), the digital filter device 400 performs processing that is the equivalent of the following three filtering on the complex signal in the frequency domain X(k) (=R(k)+jS(k): Equation (34)) generated by transformation of the complex signal x(n)=r(n)+js(n) by real number FFT.

1) Filtering with factor V(k) for R(k)

First, the digital filter device 400 performs filtering with the filter factor V(k) for the complex signal R(k) in the frequency domain obtained by real number FFT of the real part signal r(n) in the time domain. Thus, a complex filter factor in the frequency domain corresponding to the real filter factor when performing filtering by real number calculation in the time domain on the real part signal r(n) is assigned to V(k).

2) Filtering with factor W(k) for S(k)

Likewise, the digital filter device 400 performs filtering with the filter factor W(k) for the complex signal S(k) in the frequency domain obtained by real number FFT of the imaginary part signal s(n) in the time domain. Thus, a complex filter factor in the frequency domain corresponding to the real filter factor when performing filtering by real number calculation in the time domain on the imaginary part signal s(n) is assigned to W(k).

3) Filtering with factor W(k) for filtering results of 1) and 2)

Then, the digital filter device 400 performs filtering with the filter factor H(k) for a complex signal R(k)V(k)+jS(k)W(k) composed of R(k)V(k) and S(k)W(k) after the above-described two filtering performed independently of each other.

R(k)V(k)+jS(k)W(k) is a complex signal in the frequency domain corresponding to a signal in the time domain composed of two signals obtained by independently performing filtering of the real part signal r(n) and the imaginary part signal s(n) in the time domain. The signals obtained by independently performing filtering of the real part signal r(n) and the imaginary part signal s(n) correspond to X′(k) and X′*(N−k) in FIGS. 12 and 13. The signal in the time domain composed of r′(n) and s′(n) corresponds to x″(n) in FIG. 10. In this manner, R(k)V(k)+jS(k)W(k) is a signal in the frequency domain corresponding to a signal in the time domain obtained by independently performing filtering of the real part and the imaginary part in the time domain.

Thus, in order to perform, on the signal R(k)V(k)+jS(k)W(k) in the frequency domain, processing that corresponds to filtering by complex number calculation on a complex signal in the time domain, the following factor is used. Specifically, a complex filter factor in the frequency domain corresponding to a complex filter factor when performing filtering by complex number calculation in the time domain on the complex signal x(n) is assigned to H(k).

As described above, in this example embodiment, three types of filters are set from the outside. Specifically, the filter factors V(k) and W(k) in the frequency domain corresponding to filter factors in the time domain respectively for the real part and the imaginary part of the complex signal x(n), and the factor H(k) in the frequency domain corresponding to a filter factor in the time domain for x(n) are set. By performing filtering using two factors obtained from the above three factors, FFT before filtering and IFFT after filtering need to be performed only once.

### Effects of Second Example Embodiment

As described above, in this example embodiment, filtering is performed using two types of filter factors in the frequency domain corresponding to filter factors in the time domain respectively for the real part and the imaginary part of a complex signal, and a factor in the frequency domain corresponding to a filter factor in the time domain for a complex signal. Specifically, filtering in the frequency domain corresponding to independent filtering by real number calculation on each of the real part and the imaginary part of a complex signal in the time domain and filtering by complex number calculation on a complex signal in the time domain is performed. This allows desired filtering to be implemented using only one FFT circuit that performs FFT before filtering and only one IFFT circuit that performs IFFT after filtering. This has the effect of reducing the circuit size and power consumption for performing filtering.

Further, the FFT circuit 10 according to the first example embodiment of the present disclosure or the FFT circuit 20 according to the second example embodiment of the present disclosure can be used to implement the FFT circuit and the IFFT circuit. As described earlier, the FFT circuit according to the example embodiment of the present disclosure is able to output X(k) and X(N−k) in the same cycle for any index k between 1 and N−1. Thus, there is no need to add a circuit for sorting in the filtering process. Therefore, by using the FFT circuit according to the example embodiment of the present disclosure for filtering, the effect of reducing the circuit size and power consumption for filtering is obtained.

Note that the present disclosure is not limited to the above-described example embodiments and can be modified as appropriate without departing from the spirit and scope of the present disclosure.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A fast Fourier transform device comprising:
a data sorting unit configured to sort N (N is an integer) number of first input data in a first order, and output N number of first output data in a second order;
a twiddle multiplication unit configured to perform twiddle multiplication that multiplies the N number of first output data by a twiddle factor, and output the N number of first output data in the second order; and
a butterfly computation unit configured to perform butterfly computation on the N number of first output data, and output the N number of second output data in the second order,
wherein the second order is an order where the N number of second output data X(k) (0≤k≤N−1) and X(N−k) have a time lag of one cycle or less for any index k between 1 and N−1 of X(k), and a bit transition rate between consecutive cycles of the twiddle factor is small.

2. The fast Fourier transform device according to claim 1, wherein when the N number of second output data X(k) (k is an integer of 0≤k≤N−1, N is the number of points of fast Fourier transform or inverse fast Fourier transform), the data sorting unit outputs X(k) and X(N−k) with a time lag of one cycle or less for any value of k.

3. The fast Fourier transform device according to claim 1, wherein the data sorting unit selects a candidate that minimizes a sum of Hamming distances related to a twiddle factor from a plurality of candidates for an optimization data set bit reversed order, this order being an order allowing the second output data X(k) and X(N−k) to be output with a time lag of at most one cycle.

4. The fast Fourier transform device according to claim 1, further comprising, in a previous stage of the data sorting unit,
a previous stage butterfly computation unit configured to perform butterfly computation on previous stage input data, and output the first input data.

5. A digital filter device comprising:
the fast Fourier transform device according to claim 1;
a complex conjugate generating means for generating, from first complex data, this data being a complex number in time domain and composed of the N number of second output data output from the fast Fourier transform device, second complex data containing a conjugate complex number of each number;
a filter factor generating means for generating, from first, second and third input filter factors of input complex numbers, first and second frequency domain filter factors of the complex numbers;
a first filter means for performing filtering with the first frequency domain filter factor on the first complex data and outputting third complex data;
a second filter means for performing filtering with the second frequency domain filter factor on the second complex data and outputting fourth complex data; and
a complex conjugate combining means for combining the third complex data with the fourth complex data and generating fifth complex data.
